(19) United States
(12) Patent Application Publication
(10) Pub. No.: US 2005/0186548 A1
(43) Pub. Date: Aug. 25, 2005

(54) Multimedia interactive role play system

(76) Inventor: Barbara Tomlinson, Richboro, PA (US)

Correspondence Address: Amy L Crocetti, Esq.;Metz Lewis LLC, 11 Stanwix Street, 18th Floor, Pittsburgh, PA, 15222, US

(21) Appl. No.: 11/066,348

(22) Filed: Feb. 25, 2005

Related U.S. Application Data
(60) Provisional application No. 60/547,625, filed on Feb. 25, 2004.

(51) Int. Cl. A63H 3/00; G09B 5/00

(52) U.S. Cl. 434/309

(57) ABSTRACT

A multimedia interactive role play system comprising dialogue corresponding to a plurality of characters and an accompanying prerecorded presentation having an audible portion. The dialogue of the presentation is divided into user selectable segments for selection or omission of the voice of a character or group of characters from the audible portion of the presentation. The user can customize the presentation based upon character selection or timing of scene change. The dialogue can be in the form of a script that is coded to identify each character or displayed on a video monitor. Hand puppets for the different characters of the presentation are also utilized to make the experience more dramatic for the user. The multimedia role play system assists individuals in expressing their feelings by using their imagination, or as an instructional tool, and is used in all media formats including video, digital video, audio, MPEG and MP3.

### CROSS REFERENCE TO RELATED APPLICATIONS

This application claims the benefit of U.S. Provisional Application No. 60/547,625 filed on Feb. 25, 2004.

### FIELD OF THE INVENTION

The present invention relates to a multimedia interactive role play system. More specifically, the invention, according to one aspect, relates to an interactive role play device that will enable a child, or a group of children, to act out a prerecorded dramatic presentation, or scenes of a presentation, having multiple characters, through the use of puppets and preselected dialogue associated with the characters.

### BACKGROUND OF THE INVENTION

Acting provides children with an outlet to experiment with conflicts and methods of problem solving. Childrens' awareness of self and their relationships with others are expanded by problem solving such that they can identify and modify or eliminate negative behaviors. However, children do not have the sophistication of language that is often required to express certain feelings. Children are able to adapt to certain social situations and be more easily educated in academics through interaction of a type that does not involve the child as the focus of the learning situation. Accordingly, children can learn to communicate more effectively by acting out a dramatic role play through the use of puppets. Puppets are effective for dramatic role play because the puppets can be used as an extension of the individual for self-expression. This allows the focus to be diverted from the person to the lesson to be learned by the user.

For example, a child who is not feeling well may have a hard time expressing symptoms to an adult. Specifically, a child who has a serious illness may be experiencing feelings of guilt, sadness and fear. The child may feel he is disappointing the adult by being ill. Similarly, the child may be at the center of a certain social situations, such as being bullied by another child, or perhaps the child is the bully. In either situation, the child may not be able to express the reasons behind his behavior. Instead of expressing his feelings, the child does not talk about the problem and may become withdrawn.

Typically, with a role play situation, more than one individual is needed to utilize an associated device. A child who wants to act out a role playing situation cannot do so by himself because more than one individual is needed for dialogue. Dramatic role play devices that an individual can utilize alone lack the means for creative input of the user.

A number of interactive devices are identified in the prior art which illustrate devices that allow an individual to utilize his input in the operation of the device. An example is Pash, et al., U.S. Pat. Nos. 4,606,726 and 4,753,597, issued Aug. 19, 1986 and Jun. 28, 1988, respectively. Pash, et al., discloses an interactive recording having a plurality of segments representing possible branches of a story, each segment being user selectable. The recording is ideally suited for decisional instruction in which the user selects a new segment from at least two choices. Consequences of the choices of the user are presented as story development.

The interactive recording is a segmented prerecorded audio delivery medium, such as a phonograph record or a cassette tape, with each segment having a visual identification, such as color or pattern. The user listens to the first segment and at the end is presented with a choice of two or more segments which represent branches of the story. After the user identifies the next branch of the story, he selects the appropriate segment for that branch on the prerecorded audio delivery medium by its visual identification. The recording is utilized in combination with a play mat which can either be two or three dimensional. The mat displays pictures or other information referred to in the story and is specifically marked to correspond with segments of the recording in which the subject matter is discussed. Additional pieces, such as trackers which are also marked to correspond with the appropriate track segments, are used during the specific segment in which the piece is discussed.

Although Pash, et al., is described as an interactive recording, it is not a true interactive device that allows user input and self-expression. Pash, et al., is a prerecorded medium that provides a method for decision making with regard to a story line. The device does not contain any means for user input. Further, the play mat and associated trackers are markers that can be manipulated only in accordance with the storyline.

If the story is about a birthday adventure in a store where the user is prompted to choose desired birthday gifts, the play mat and trackers are color coded according to the recording and are moved during the listening experience to represent the user's selections from the options presented. The play mat and trackers therefore provide only passive expression while utilizing the device. While the Pash, et al. device provides an opportunity for a child to play with the device alone and sharpen important decision making skills, the device does not provide a means for self-expression.

Gemma, Jr., U.S. patent Publication No. 2003/0162471, published on Aug. 28, 2003 discloses a device that combines a story media with puppet figures to assist the user in the creation of a puppet show. The story media may be a book, a CD-ROM or an audio cassette tape which contains a play or story. The device is a box having a stage-like opening and a puppet manipulator, which is a glove-shaped object having four finger portions. The user selects or creates relevant puppet figures which represent characters or objects related to the story media. The different puppet figures are removably attached to the puppet manipulator to enable the user to act out the play or story. The device provides an opportunity for a user to represent several characters selected from story media at the same time through the puppets that are attached to the manipulator. New characters can be added or removed from the manipulator depending on the story.

Gemma, Jr., is similar to Pash, et al., in that a user can utilize the device alone. Gemma, et al., is different because it allows the user some creative input. A user may exhibit self-expression in the creation of the puppets that represent the characters of the story. However, the users must ultimately act out the role of each character in the story or scene. Gemma, et al., does not provide the ability for the user to interject their voice for a character's part in the story in conjunction with the prerecorded story lines of the other characters.

La Tour, et al., U.S. Pat. No. 5,888,070, issued on Mar. 30, 1999, discloses an electronic learning tool having a prerecorded multipart drama and an accompanying story script. An individual can selectively mute a portion of the prerecorded drama and substitute the user's voice for that portion. The device has a microphone that permits variation of the allotted input time during which the multipart drama is muted. The device also provides prerecorded control signals which provide cues to the user when voice input into the device is required. When the user reads the selected part into the microphone, the playback of the selected part of the multipart drama is muted so that the user can read that part into the microphone. The reader's voice is recorded along with the remaining unmuted prerecorded drama so that a recorded version is produced with the reader's voice substituted for one of the prerecorded parts.

In La Tour, et al., the prerecorded multipart drama is divided into multiple tracks. One or more tracks each contain a single character, and another track has any additional characters and sound effects. An additional track contains the control signals that provide the cues to the user. The user is only partially integrated into the story because his participation is limited. The user can only act as the character on a track that is specifically dedicated to a single character. Users cannot participate as more than one character at any time in the story because only single character tracks can be muted. Further, multiple users cannot use the device simultaneously to represent additional characters. Also, the end product of the user's contributions is a recording containing the user's voice reading a character's role for later playback as a recording. The user does not actively participate in the real-time dramatic performance of the story.

Baer, U.S. Pat. No. 4,846,693, issued on Jul. 11, 1989, discloses an animated doll that has the capability to move its eyebrow, eyelids, eyes and mouth in connection with a speaker interior to the doll. A video display device is connected to a video cassette player which has its audio and video output routed to a control box. A video cassette medium is prerecorded to contain audio and video signals which are utilized in the video display. The control box also routes the audio and video data contained on the medium to the speaker interior to the animated doll. The data activates the moving parts in synchronization with the display on the television monitor. The device creates an illusion that the doll is having a conversation with the characters displayed on the television monitor.

In its simplest embodiment, the animated figure appears to engage in conversation with characters on the screen while the user watches. In another embodiment, although the doll appears to be interacting with the user, the doll is prompted by signals received through input of the user on an input control device. For example, the doll may interact with characters on the television screen as displayed by the video cassette recorder, but this interaction is controlled by the input of the user to questions posed in the context of the video presentation. Verbal responses of the doll are not triggered in response to verbal user input, but rather the verbal responses are based upon the manual input of the user. The user has the ability to input yes or no answers or multiple choice answers by pushing the appropriate buttons on the input control device. The user always remains a passive bystander in the interaction because it is limited to verbal and gestural responses to the user's limited manual input. The user never becomes an active character in the storyline.

Finally, Kirwan, U.S. Pat. No. 6,516,181, provides a combination storybook with a separate audio recording and playback device that is removably attached to the story book apparatus. The audio recording and playback device is used to playback recorded audio. The audio device has buttons correlated to the storybook by color or page number that, upon selection by the user, enable the playback of the recorded material allowing a user to hear, as well as read, a story in the story book. The audio may be divided into tracks so that the recorded story is separate from non-speaking parts, such as background music.

Kirwan does not provide a means for the user to actively participate in a dramatic performance of the story. The user merely has the ability to record narrative of a story for future playback. The user's creative input is limited to the recording of story selections.

What is lacking in the art, therefore, is a true interactive role play system that comprises a combination of a dialogue, puppets, and a prerecorded dramatic presentation that allows a user to remove preselected characters from the presentation for the purpose of allowing a user or group of users to actively participate in the storyline as the preselected characters. Users can substitute their own voices for the preselected character or characters chosen while simultaneously acting out the scene with an appropriate hand puppet.

### SUMMARY OF THE INVENTION

An interactive role play system is disclosed that will enable a child to act out stories through the use of puppets, a dialogue and a prerecorded dramatic presentation such that one user or multiple users can selectively substitute their voice for the preselected voices of characters in the presentation. The user or group of users can substitute their voice for any or all of the preselected character voices.

The disclosed interactive role play system includes the dialogue in script form so that the user can read aloud the role of a character or characters during the presentation. The script is both color and icon coded to assist the reader to find the appropriate lines quickly. The script may also contain illustrations regarding the content of the presentation so the user can follow the action occurring at a particular point in the dialogue. The user can read the script as the presentation progresses so he knows how and when to substitute his own voice for the particular character or character he is representing.

The disclosed interactive role play system allows the user to become an active character in the presentation he is reading. The presentation may consist of a series of dialogue segments which are preferably, individually associated with each character's audible content. These segments may comprise tracks in the preferred media embodiment of a CD or DVD. Each successive track has a different character or set of characters voices omitted allowing the user to select the voice he would like to imitate and inject himself into the presentation. Alternatively, the presentation may permit the selective omission of characters from a unified track.

The disclosed invention also includes hand puppets that represent the different characters in the presentation and accompanying dialogue. The puppets act as a creative outlet for the user to express his own feelings. A child who is not skilled in language or who feels vulnerable displaying emotion is more likely to act out his feelings through the use of a puppet.

The disclosed invention may assist the user in self-expression. The dialogue of the presentation may relate to specific problems or events in an individual's life. The device can be used on a therapeutic level to help a child or an adult that has problems expressing himself. The content of the presentation can be a specific problem or event that a person is experiencing in his life including, but not limited to, the end of a relationship, divorce, death, fears, or obsessive compulsions. The system may be used on an educational level to teach young users word recognition and reading skills. The system may also be used to teach a user about more serious topics such as drugs or crime. The system may be used to teach a variety of subjects. The subject matter of the system may be an event in history and involve historical figures.

### BRIEF DESCRIPTION OF THE DRAWINGS

FIG. 1 is a diagrammatic representation of a script in accordance with the present invention.

FIG. 2 is a diagrammatic representation of the major components in the system of the present invention.

### DESCRIPTION OF THE PREFERRED EMBODIMENTS

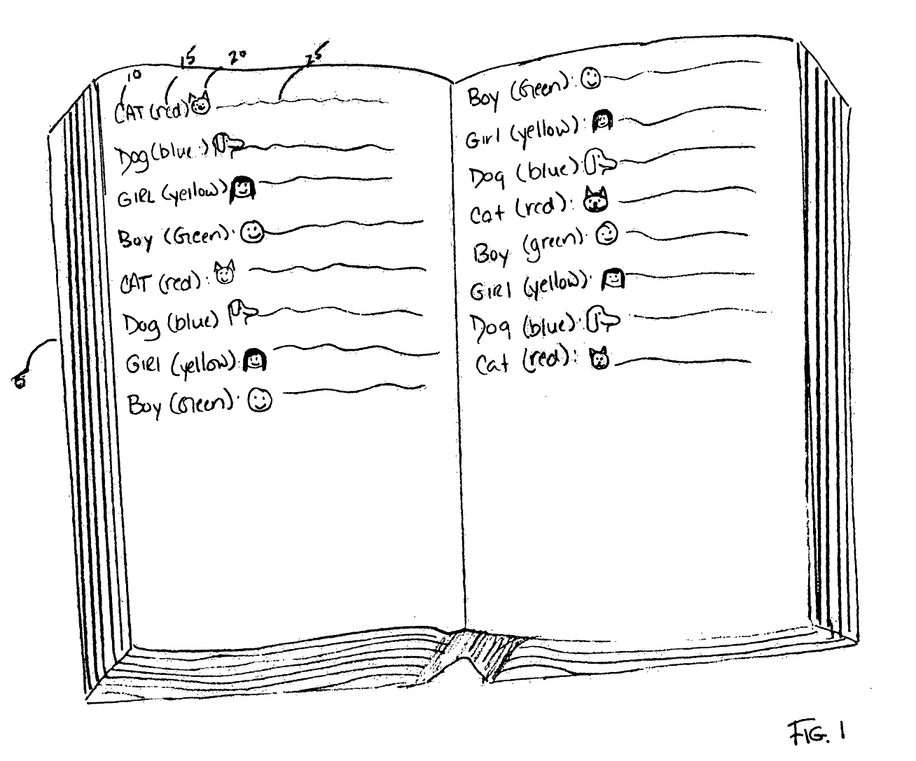

FIG. 1 illustrates a view of a script 5. Script 5 contains the written text of the presentation in a script format. The text of script 5 outlines the lingual elements required to act out the presentation. The format of script 5 contains certain elements to enable the user to easily act in the role of a selected character by following the dialogue of the character.

Character name 10 identifies the character of the presentation delivering spoken words at a particular time. Character line text 25 is the dialogue associated with each particular character of the presentation. The character corresponding to character line text 25 and character name 10 is identified in several ways. First, each character name 10 is associated with a character icon 20. Character icon 20 represents a character in the presentation and each character has a unique character icon 20. For example, if the character is a girl, character icon 20 is a depiction of a girl. The character icon 20 of the girl appears next to every line of character line text 25 through the entire script. Second, each character is identified by character color code 15. Each character in the presentation and accompanying script 5 is accorded a different character color code 15. Like the identification method of the character icon, the character color code 15 is associated with the character throughout the entire script 5. The character color code 15 is used to identify the character name 10, character icon 20 and any character line text 25. These elements appear in the color represented by character color code 15.

In an alternative embodiment the character color code 15 can be used to identify only one of the character name 10, character icon 20 or character line text 25 or any combination thereof for each character. The character color code 15 can also be omitted so that each of the character name 10, character icon 20 and character line text 25 are identified in one unified color for each character. It can be appreciated that the elements in script 5 can vary in order or that a particular element can be omitted from script.

The characters of script 5 are identified by character color code 15 and character icon 20 so that the user can easily read the presentation and quickly identify the dialogue associated with the selected character or characters. For example, referring again to FIG. 1, character Cat is identified by its character name 10. The Cat character icon 20 is printed next to the Cat's character name 10. The Cat's character line text 25 is printed next to the Cat's character icon 20. Next, the character Dog is identified by its character name 10. The Dog character icon 20 is printed next to the Dog's character name 10. The Dog's character line text 25 is printed next to the Cat's character icon 20. The script 5 elements are associated with the Girl and Boy characters shown in FIG. 1 in a similar manner.

In an alternative embodiment, script 5 may also contain illustrations for further detail of the content of the presentation which enables the user to follow the progression of the presentation. The illustrations may provide a reference point in the content or they may be for entertainment purposes only.

The presentation is preferably a standard DVD. The DVD is comprised of a number of tracks. With reference to Table 1, track 1 of the DVD is a complete track of the presentation corresponding to script 5 and displays a video of the characters acting out the presentation with an audio of all the characters' voices, background music and sound effects. Particular background music is associated with each character in the presentation and is heard by the user as a cue to signal a character's dialogue. The background music can heard at the beginning, during the duration or at the beginning and the end of the character's dialogue although other timing can be appreciated. The background music can be a particular melody or it can be a particular sound or tonation. The sound effects of the presentation are consistent throughout and are not character-dependent.

Referring again to Table 1, track 1 contains each character of the presentation speaking its associated dialogue. Track 1 does not contain any omissions of a specific character's or characters' dialogue. Track 2 begins a series of tracks in which omissions are made of the audible dialogue of a particular character or characters from the presentation. Although each successive track of the DVD does not include certain characters' voices, based on selection by the user, the character or characters are included in the video display to provide a visual cue for the user to begin speaking as the user follows the dialogue of the presentation. The video is consistent between the versions of the presentation and only the audible portion differs between each version of the presentation.

In an alternative embodiment, when a selected character or group of characters voices are omitted from the audible dialogue, the selected character or group of characters can also be omitted from the video display to facilitate the interactivity of the corresponding user-operated hand puppets in conjunction with the video.

Although the dialogue of a selected character or characters is omitted, the background music or specific sound or tonation associated with the selected character or characters is heard. The background music or specific sound or tonation represents the selected character or characters and alerts the user that the particular omitted voice of the selected character or characters would otherwise be heard at that time. The user then substitutes the user's voice for the omitted voice of that character.

Track 3 omits the voice of a different character from the track. Again, the background music or specific sound or tonation associated with the selected character is heard to represent that the omitted of the selected character would otherwise be heard at that time. The user again substitutes the user's voice for the character's voice. Each successive track omits the voice of a different character until each character has been omitted from the presentation once.

With reference to Table 1, after each character's voice has been omitted once from the audible portion of the presentation, combinations of voices are omitted from the audible portion. Although it can be appreciated that multiple users can each substitute their voice for one omitted character voice, the omission of more than one voice from the audible portion of the presentation gives multiple users the option of substituting each of their voices for the character of their choice. For example, track 6 is the first track that omits combinations of two characters. The omission of combinations of two voices continues until those combinations have been exhausted. Again, referring to Table 1, Track 12 begins the omission of combinations of three character's voices until those combinations have been exhausted. The omission of combinations of character voices continues until, on the final track of the DVD, the voices of each character of the presentation is omitted and the audible portion of the DVD consists solely of any sound effects of the presentation and the background music or specific sound or tonation indicating the particular character's dialogue cue.

The DVD can contain an on-screen index listing all of the tracks on the DVD. The on-screen index illustrates which character or characters are omitted from a particular track. The user can select the track to be played based on the selected character or characters voices to be omitted from the audible portion of the presentation.

It is to be specifically noted that alternative methods of electronic storage of the program storage can also be utilized. These alternative methods can include the use of optical or magnetic media that include a unified data file, which is not track-based but uses alternative methods for locating or pointing to the particular sections of the track to be played. Alternative embodiments can further include separate electronic files including data for individual characters and/or timing of the prerecorded parts which can be selectable at the user's request or command.

For example, the DVD can contain an on-screen index of the characters in the presentation. The user chooses a character or group of characters from the on-screen index and the device selects the relevant media selections that contain the chosen character or group of characters. In this embodiment, the user has an option to customize the presentation and completely eliminate a character or group of characters from the particular role play situation through a selection of character based segments.

Further, the DVD can present the user with the option of maintaining a video display of a specific scene so that user can take as much time as necessary to substitute the user's voice for the omitted dialogue of the characters or create new dialogue improvisationally before continuing to the next scene. In this embodiment, the user can set the device to advance the presentation to the next scene after a time interval, or the user can advance to the next scene manually.

The DVD can further include basic instructional tracks, such as a demonstration of how to use the device, or how to walk, talk and act out different emotions with puppets. The DVD can contain an additional track for the identification of each character in the presentation. With reference to Table 1, each character has a program or introductory material that, upon selection, depicts the particular character while the associated background music or specific sound or tonation is heard.

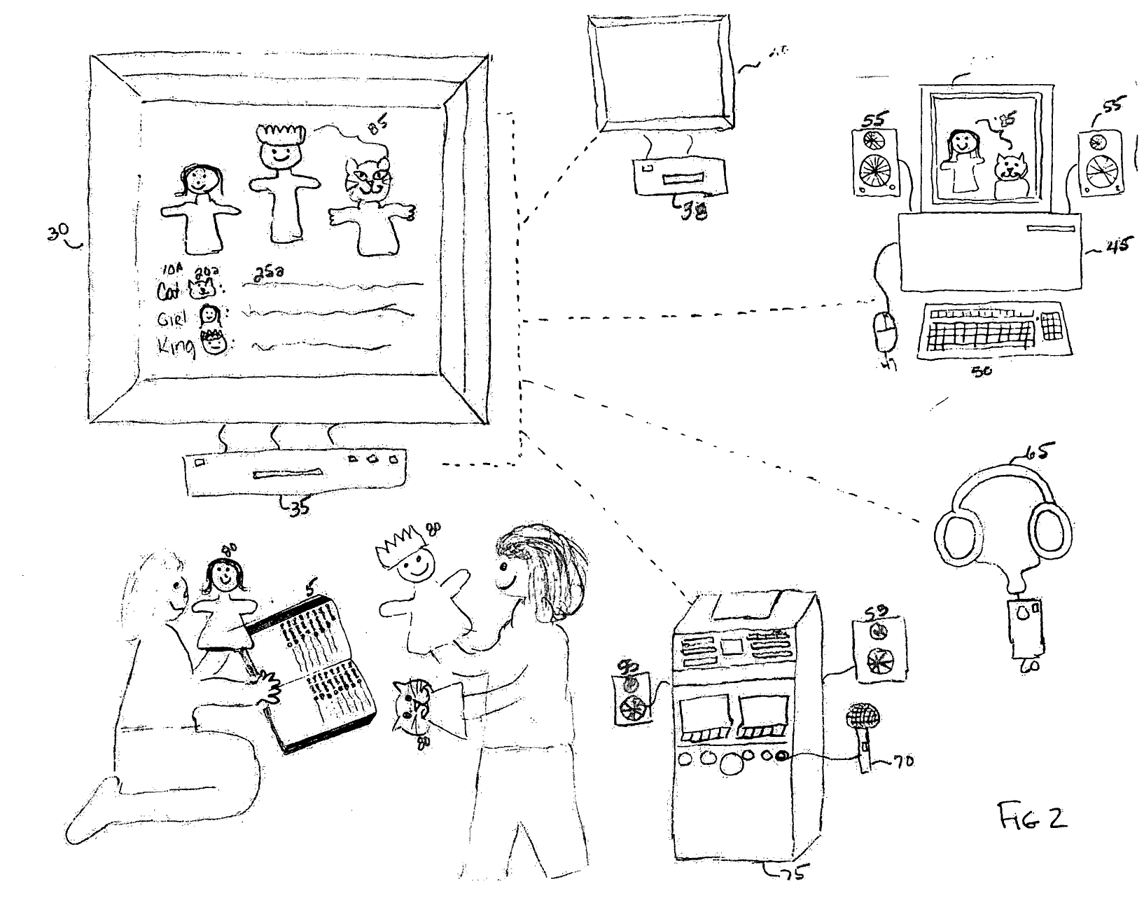

FIG. 2 is a pictorial representation of the major components of the system. Each character of script 5 is associated with a particular hand puppet 80. Hand puppet 80 can be included with the presentation or the user can create and customize a puppet. Although hand puppet 80 makes the presentation more interactive, it can be appreciated that hand puppet 80 is not required to use the system.

The user inserts the DVD containing the presentation into a playback device, such as a DVD player 35, and selects the appropriate track. Once selected, the video of the track is displayed on video display 30. The video displayed on video display 30 includes character screen display 85. The character screen display 85 is a representation of the character of the presentation that also corresponds to hand puppet 80. The user follows script 5 for the progression of the dialogue in the presentation.

Alternatively, the video displayed on video display 30 can also include any combination of character name display 10a, character icon display 20a, and character line text display 25a. The character name display 10a, character icon display 20a and character line text display 25a correspond to the associated portions of the script 5 but are presented on the screen so that the user can follow the dialogue on video display 30. The character line text display 25a shown on video display during the dialog of each character can have a form of highlighting so the reader can reinforce his reading skills. This highlighting can reference each line, character or such word as the character speaks.

In an alternative embodiment, the presentation is in the format of a video cassette tape that is played on a playback device that is a video cassette player 38. Video contained on the video cassette tape is displayed on video display 30. The user forwards through the video with the corresponding buttons on video cassette player 38 to select the appropriate portion of the video where the selected characters or characters' voices are omitted.

In another alternative embodiment, the presentation is in the format of a compact disc read-only memory, also known as a CD-ROM. The CD-ROM is playable in the compact disc drive of a personal computer 39. When the CD-ROM containing the presentation is inserted in the central processing unit 45 of personal computer 39, a track listing display similar to that contained on the DVD is displayed on monitor 40. A user selects a particular track using either a mouse 47 or a data entry device 50. After the user selects the desired track, the video contained on the CD-ROM is displayed on monitor 40 and the audible portion of the CD-ROM is heard through audio speaker 55.

In a variation of this embodiment, the presentation format can be a digital compressed file, such as an MPEG file, that the user downloads or saves to a location on personal computer 39. The user selects the MPEG file from the file directory of personal computer 39 and plays the video on any video player compatible with that type of file format. The MPEG file displays the video on monitor 40 and the audible portion is heard through audio speaker 55.

In another embodiment, the presentation format is an audio only digital format that may or may not be digitally compressed, such as a WAV file or an MP3, file, respectively, that the user downloads and saves to a playback device having the ability to save the information, such as a personal audio player 60. The user downloads the audio file from the World Wide Web directly to personal audio player 60 or the user downloads the file to personal computer 39 for later transfer to personal audio player 60. When the audio file is played on personal audio player 60, the audible portion of the presentation is heard through personal stereo headphones 65 while the user follows along with script 5.

In a variation of this embodiment, the presentation can be a CD-ROM medium that contains only an audible portion. The CD-ROM can be broadcast by any playback device that incorporates a compact disc player.

In another embodiment, the playback device can be a karaoke machine 75. It can be appreciated that in this embodiment the presentation can be one of a cassette tape, a video cassette tape, a CD-ROM or a DVD. The audible of the presentation is heard through audio speaker 55. The user speaks the dialogue of the omitted voice of the selected character or group of characters into microphone 70. Karaoke machine 75 can have a video display 30 which displays the character display 85, character name 10a, character icon 20a and character line text 25a.

TABLE 1

| Track 1 | | Track 2 | | Track 3 | |
|---|---|---|---|---|---|
| Character | Omitted | Character | Omitted | Character | Omitted |
| A | No | A | Yes | A | No |
| B | No | B | No | B | Yes |
| C | No | C | No | C | No |
| D | No | D | No | D | No |
| Track 4 | | Track 5 | | Track 6 | |
| Character | Omitted | Character | Omitted | Character | Omitted |
| A | No | A | No | A | Yes |
| B | No | B | No | B | Yes |
| C | Yes | C | No | C | No |
| D | No | D | Yes | D | No |
| Track 7 | | Track 8 | | Track 9 | |
| Character | Omitted | Character | Omitted | Character | Omitted |
| A | Yes | A | Yes | A | No |
| B | No | B | No | B | Yes |
| C | Yes | C | No | C | Yes |
| D | No | D | Yes | D | No |
| Track 10 | | Track 11 | | Track 12 | |
| Character | Omitted | Character | Omitted | Character | Omitted |
| A | No | A | No | A | Yes |
| B | Yes | B | No | B | Yes |
| C | No | C | Yes | C | Yes |
| D | Yes | D | Yes | D | No |
| Track 13 | | Track 14 | | Track 15 | |
| Character | Omitted | Character | Omitted | Character | Omitted |
| A | No | A | Yes | A | Yes |
| B | Yes | B | No | B | Yes |
| C | Yes | C | Yes | C | No |
| D | Yes | D | Yes | D | Yes |

| Track 16 | | | |
|---|---|---|---|
| Character | Omitted | Track 17 | Track 18 |
| A | Yes | Instructional | Identification of |
| B | Yes | | character A |
| C | Yes | | |
| D | Yes | | |

| Track 19 | Track 20 | Track 21 |
|---|---|---|
| Identification of | Identification of | Identification of |
| character B | Character C | Character D |

1. A multimedia role play system comprising:
a prerecorded dramatic presentation having an audible portion;
preselected dialogue corresponding to said prerecorded dramatic presentation and incorporating dialogue segments corresponding to a plurality of characters; and
a playback device for the broadcast of said prerecorded dramatic presentation, said playback device having a selection component to identify and select user-identified dialogue segments of said preselected dialogue from the audible portion of said prerecorded dramatic presentation for broadcast.

2. A multimedia role play system as described in claim 1, wherein said user-identified dialogue segments are omitted from said audible portion of said prerecorded dramatic presentation.

3. A multimedia role play system as described in claim 1, wherein said prerecorded dramatic presentation is divided into character based segments.

4. A multimedia role play system as described in claim 3, wherein said character based segments have associated character specific identifiers to enable preselection by a user.

5. A multimedia role play system as described in claim 1, wherein said prerecorded dramatic presentation is in a multimedia format being selected from the group consisting of video, digital video, audio, MPEG and MP3.

6. A multimedia role play system as described in claim 1, wherein said prerecorded dramatic presentation is in a multimedia format that is divided into tracks.

7. A multimedia interactive role play system as described in claim 1, wherein said prerecorded dramatic presentation is divided into scenes.

8. A multimedia interactive role play system as described in claim 7, wherein a user specifies a time interval for scene advancement.

9. A multimedia interactive role play system as described in claim 7, wherein said scene is advanced manually by user.

10. A multimedia role play system as described in claim 1, wherein the audible portion of said prerecorded dramatic presentation further comprises a unique identifier to represent each of said characters.

11. A multimedia role play system as described in claim 10, wherein the unique identifier is background music.

12. The multimedia role play system as described in claim 1, wherein said preselected dialogue is in the form of a script.

13. A multimedia role play system as described in claim 12, wherein said script further comprises a character name and associated character line text for each of said characters.

14. A multimedia role play system as described in claim 12, wherein said script further comprises a character icon to identify each of said characters.

15. A multimedia role play system as described in claim 12, wherein said script has a color code for each of said characters.

16. A multimedia role play system as described in claim 1, further comprising a video display for displaying said preselected dialogue.

17. A multimedia role play system as described in claim 16, wherein said prerecorded dramatic presentation further comprises a video portion.

18. A multimedia role play system as described in claim 17, wherein said character associated with said omitted user-identified portion of said preselected dialogue is omitted from the video portion of said prerecorded dramatic presentation.

19. A multimedia role play system as described in claim 1, further comprising a puppet to represent each of said characters.

20. A multimedia role play system as described in claim 19, wherein said puppet is custom created by the user.
